(19) United States
(12) Patent Application Publication
(10) Pub. No.: US 2013/0260357 A1
(43) Pub. Date: Oct. 3, 2013

(54) Skill Screening

(71) Applicant: Lauren Reinerman-Jones, Winter Park, FL (US)

(72) Inventor: Lauren Reinerman-Jones, Winter Park, FL (US)

(21) Appl. No.: 13/431,500

(22) Filed: Mar. 27, 2012

(51) Int. Cl. G09B 7/00

(52) U.S. Cl. 434/362

(57) ABSTRACT

A testing method enables the selection, prediction, and validation of any skill using physiological assessments, performance, and subjective responses, using a model. Determining aptitude for a task includes identifying core components of a skill related to the task, testing a first group of individuals known to possess expert skills for the task, including testing physiological response, task performance, and subjective values. Next, using statistical analyses, one or more skill indices are calculated using Bayesian classifiers, support vector machine logic, neural network logic, or regression, to produce skill indices. Next, a second group of individuals not known to possess expert skills are given the same testing, and the statistical model is used in a comparison of the second group with the first group, to predict aptitude for the task.

### FIELD OF THE INVENTION

The invention generally relates to the field of applied neuroscience, particularly to methods for screening skills; and most particularly to a selection, prediction, and validation (SPV) tool for any skill.

### BACKGROUND

Identification of individuals having potential for successful performance in certain occupations, such as air-traffic control, airport security, medical screening, financial trading, border patrol, and military operations, is improved via use of skill screening. The objective of skill screening is selection of an individual best suited for a particular position based upon an evaluation of skills required for the position. For example, vigilance or sustained attention, is necessary for military personnel, thus one would select individuals for a combat mission scoring high in vigilance.

Previous studies show that cognitive and physical skills can be subjectively assessed (i.e. by use of questionnaires) and objectively assessed (i.e. measure of performance and/or physiological responses). Examples of cognitive skills include vigilance, situation awareness, memory, pattern recognition, decision making, problem solving, meta-cognition, critical thinking, adaptability, creativity, leadership, teamwork, communication, empathy, and resilience. Examples of physical skills include cardiovascular/respiratory endurance, stamina, strength, flexibility, power, speed, coordination, agility, balance, and accuracy.

Citation or identification of any reference/document in the instant application is not and should not be interpreted as an admission that such reference/documents is available as prior art to the present disclosure.

### SUMMARY OF THE INVENTION

The method of the disclosure for skill screening describes an integrated software and hardware solution to identify personnel who have a natural aptitude for a skill through the use of a detailed quantitative multi-dimensional approach.

In one embodiment, an automatically-generated Bayesian model is used to access one or multiple skills of an operator based on user profile, task performance, and physiological sensor data. The model developed for a group of operators in one task can be transferred to assess skills of operators in the same group for other similar tasks. Additionally, the model developed for a group of operators on one task can be transferred to screen operators in a different group for that same task.

In the context of the disclosure, various neural, cognitive, and behavioral data are collected, fused, and analyzed for skill assessment. The model is thus built upon a multi-dimensional approach (subjective questionnaires, performance, and physiological responses) and can be transferred to different tasks and/or to different individuals. The multi-dimensional approach enables capture of subtle and sensitive changes of task performance across the different individuals and tasks.

According to one aspect of the disclosure, there is provided a selection, prediction, and validation (SPV) tool or apparatus for generating an index of a level of a skill for and thus selecting an individual or team. The apparatus encompasses physiological sensors/measures including, but not limited to, transcranial Doppler (TCD), electroencephalogram (EEG), electrocardiogram (ECG), eye tracking, galvanic skin response (GSR), function Near Infrared (fNIR), Near Infrared (NIR), and electromagnetic resonance (EMG) for short battery response and skill assessment.

The apparatus can also include, but is not limited to, subjective measures such as the NASA-Task Load Index (NASA-TLX), Big Five Personality Test, Myers Briggs test, Dundee Stress State Questionnaire (DSSQ), Instantaneous Self-Assessment (ISA), Trait Emotional Intelligence Questionnaire (TEIQue), and other questionnaires for short battery response and skill assessment.

The apparatus can further include, but is not limited to, performance measures such as correct response, response time, incorrect answers, number of mouse clicks, number of words used, and other performance measures for short battery response and skill assessment.

The apparatus also includes short tasks and a longer task, each for a given skill and generated for any skill.

One embodiment of the selection, prediction, and validation (SPV) tool or apparatus includes physiological, subjective, performance, and objective measures for short battery response and skill assessment.

In another aspect, the disclosure provides a method for predicting an individual's or team's skill level by the short battery preceding a longer task and capturing enough of the different processing requirements of the skill or skills. The skill predicting includes predicting a skill at a general level, at core components, and at the attributes of the components.

In another aspect, the method can include a model made from an expert sample group using advanced statistics such as Bayesian and Support Vector Machines/Regression. Model output of variables for the carefully chosen battery and skill assessment determines an index of the skill or skills with the components and attributes.

In another aspect, the disclosure provides a method for validating a selection and prediction tool. This method includes, but is not limited to, a comparison of an individual or team to an expert normalized model. More specifically, the expert group performs the short battery, a task 1, and a task 2 or returns for a longitudinal follow-up in which they complete the short battery and task 2. This would validate at one level, but a second group of people (the group sought to select and predict) also completes the short battery and the task 1. Validation in this way enables selection and prediction based on the best of the best for a given skill or skills.

One aspect of the disclosure provides a selection, prediction, and validation (SPV) tool or apparatus for selecting individuals suited or not suited for performing a given skill.

Another aspect of the disclosure provides a selection, prediction, and validation (SPV) tool or apparatus for predicting skill level.

A further aspect of the disclosure provides a method for validating a selection and prediction apparatus for any skill.

A skill can be defined as the ability of a person to apply knowledge to perform a task or an action. A skill can also be defined as the capacity to learn or acquire an ability. An ability can be described as a natural or acquired skill or talent, referring to mental or physical capacities. Aptitude refers to a person's natural ability or capacity for learning. Skill, ability, aptitude, talent, and capacity are used synonymously herein and refer to both physical and mental tasks and performances. These represent only a few definitions for skill and its synonyms. It should be understood that the definition of skill should not be limited to these definitions. A skilled artisan will appreciate that other definitions of skill might be found in pertinent literature. The description herein is intended to encompass all such definitions of skill.

Other aspects of this disclosure will become apparent from the following description taken in conjunction with the accompanying drawings, wherein are set forth, by way of illustration and example, certain embodiments of this disclosure. The drawings constitute a part of this specification and include exemplary embodiments of the present disclosure and illustrate various features thereof.

### BRIEF DESCRIPTION OF THE DRAWINGS

A more complete understanding of the present disclosure may be obtained by references to the accompanying drawings when considered in conjunction with the subsequent detailed description. The embodiments illustrated in the drawings are intended only to exemplify the disclosure and should not be construed as limiting the disclosure to the illustrated embodiments.

FIG. 1 is a diagram illustrating the creation of the short battery for predicting one or more skills and for providing scores for one or more skills.

FIG. 2 is a block diagram illustrating the validation process for constructing a validated selection battery and validated prediction model for one or more skills.

FIG. 3 is a flowchart illustrating how an indication for selecting an individual or team for a skill level is generated.

FIG. 4 is a block diagram illustrating how a model is built for predicting one or more skills for an individual or team.

FIG. 5 is a block diagram illustrating how a model is trained.

FIG. 6 illustrates a computing system upon which the methods of the disclosure may be implemented.

### DETAILED DESCRIPTION OF THE INVENTION

For the purpose of promoting an understanding of the principles of the disclosure, reference will now be made to embodiments illustrated herein and specific language will be used to describe the same. It will nevertheless be understood that no limitation of the scope of the disclosure is thereby intended. Any alterations and further modification in the described methods, techniques, tools, apparatuses, and/or any further application of the principles of the disclosure as described herein, are contemplated as would normally occur to one skilled in the art to which the disclosure relates.

Prior art methods for skill screening have focused on either subjective or performance measures. These methods require prohibitively lengthy test times, are expensive to validate, and are generally unreliable as compared with the methods of the disclosure. Subjective measures such as the use of questionnaires have been used in traditional skill screening for years, but in accordance with the instant disclosure, it is determined that questionnaires cannot provide a real-time assessment of skills and performance deterioration during a test battery, job task, or operation. On the other hand, performance measures can describe changes in performance to a limited extent, but are not consistent in predicting future performance for the same or similar task or skill.

In accordance with the disclosure, it has been determined that it is difficult to predict a person's skill level with any certainty using prior art methods. This same challenge applies to developing and/or maintaining a skill. In job selection, it is routine to select a person for a position based on inferred fit determined by the person's responses to a personality questionnaire administered by human resources (HR). Success in sports is often predicted from batting averages (baseball), free throws (basketball), or yards passed (football). Employees are grown in a skill based upon recommendations from tried and true preceding leaders. In accordance with the disclosure, all of these solutions fall short by taking a unidimensional approach, subjective only method, and validation with a generalized population.

The performance-based assessment methods of the prior art do not predict the performance of an operator in a different task scenario. In addition, the prior art does not consider the application of the method across individuals and tasks.

The prior art attempts to identify the correlation between subjective measures and performance measures for vigilance skills. For example, the instant inventor studied the relationship between cerebral blood flow velocity (CBFV) and subjective stress measures during a short battery of tasks for predicting the performance of a long task. A multidimensional approach used transcranial Doppler (TCD) ultrasonography (Helton et al. J Clin Exp Neuropsychol 29(5):545-552 2007) to measure cerebral blood flow velocity to the brain and the Dundee Stress State Questionnaire (DSSQ) (Matthews et al. Emotion 2(4):315-340 2002) to assess stress during a short battery of tasks to predict subsequent vigilance task performance. The prediction model used was hierarchical regression and then later structural equation modeling. The approach (TCD and DSSQ) was validated through the basic science principle of using different vigilance tasks for different university student samples. This approach assesses only one subjective state, and uses only one sensor system to record one type of physiological response. The results indicated that both CBFV and subjective stress measures were predictive of vigilance skill (accounting for 9-24% of the variance), but the instant disclosure further predicts this skill and other skills across different individuals and tasks.

The instant disclosure identifies a need to expand and extend work in skill screening on all fronts. Specifically, additional physiological measures, subjective questionnaires, and performance metrics are used on a short battery of skill-specific tasks to predict, through advanced statistical models, any skill.

In the method of the present disclosure, data from different sources is collected, categorized, synchronized, fused, and validated for skill assessment. The disclosure thus provides a device and method for the selection, prediction, and validation (SPV) for skill screening.

Any or all of the foregoing steps or are performed using one or more computers, computer workstations, embedded systems, computer based appliance, or other computing device, hereinafter computer system 100, executing software stored on non-transitory media. Computer system 100 may be formed of several different computing devices, each executing software performing like or dissimilar tasks, the results of which are coordinated to produce a useful result, as further described herein.

This multi-dimensional method captures subtle and sensitive individual differences using subjective and objective measures and provides reliable and valid measures for skill indexing. Objective measures may be accomplished using linear logic embedded in software executing upon computer system 100, and subjective measures may be accomplished using linear logic, or artificial intelligence software techniques. The method of skill screening described herein can enhance predictive capability and further supports adaptation of the model from one group or task to another.

One aspect of the disclosure includes a method for skill screening using training and test data to construct models. Many machine learning methods work well when the training and test data are drawn from the same feature space and the same distribution. Therefore, most statistical models need to be rebuilt from scratch using new training data when the problem domain changes.

In skill screening, rebuilding the model for each operator is expensive and often requires lengthy training time for each of them. Transfer learning aims to modify the model learned from the previous tasks and adapt the model for a new task. See Pan et al. Knowledge and Data Engineering, IEEE Transactions 22(10):1345-1359 2010.

Transfer learning provides the theoretical foundation for model reuse and adaptation in skill screening from group to group and from task to task. Methodologies based upon transfer learning can be easily managed in a large population setting and can potentially reduce the costs of skill screening in terms of both personnel and facilities.

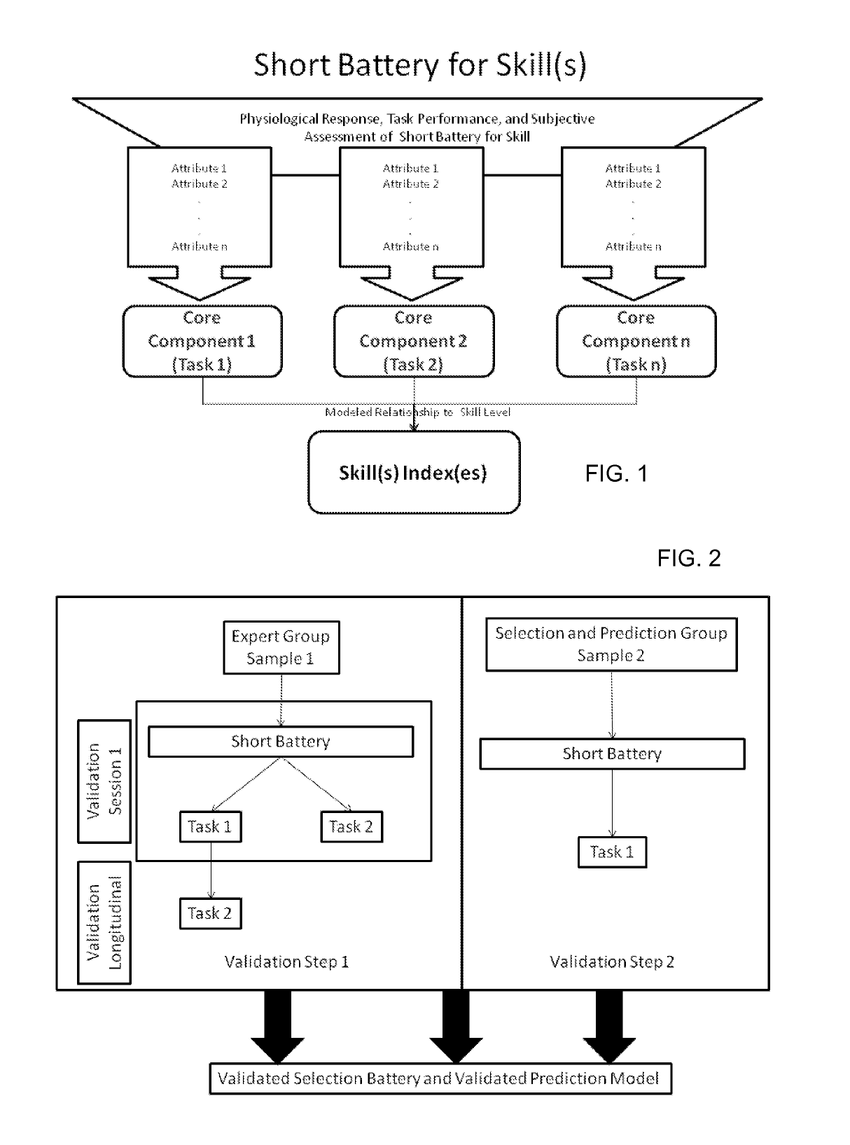

Now turning to FIG. 1, there is shown an embodiment of the creation of a short battery for one or more skills. A skill index can be given for any skill provided that the short battery is composed of core components of the skill. In a preferred embodiment, there are three core components per skill, but more are needed for multiple skills. These components are characterized by attributes. The number of attributes is dependent upon the component. Each component corresponds to a task administered and performed by an individual or team. An individual (or team) is assessed, advantageously using computer server 100, on the core components and attributes by physiological response, task performance, and subjective assessment. These responses are input into a model and one or more skill indexes are output. The core components and attributes also have an associated index. It should be understood that biologic measurements, including measurements based upon aspects of the test subject's physiology, may be controlled by, and data collected by, computer server 100, which may advantageously analyze such data according to statistical or other models encoded in software executing upon computer system 100.

The model is composed, for example, of x+y+z=skill index. The x, y, z combination yields different levels of a skill(s) for each individual or group. The validated model using experts yields some variation that can be called x_{low}+y_{low}+z_{low}=low skill index, x_{moderate}+y_{moderate}+z_{moderate}=moderate skill index, and x_{high}+y_{high}+z_{high}=high skill index. These categorical groups are used as is depending upon the field of application (a domain in which good enough is acceptable) or are normalized to be bound by a range (e.g. 0-100) or presented as a percentile, similar to a school test or a GRE. An unknown skill individual, n, completes the battery and yields nₓ, n_{y}, n_{z} as inputs for the model and these values are compared against those in the expert model to output a categorical or normalized skill index.

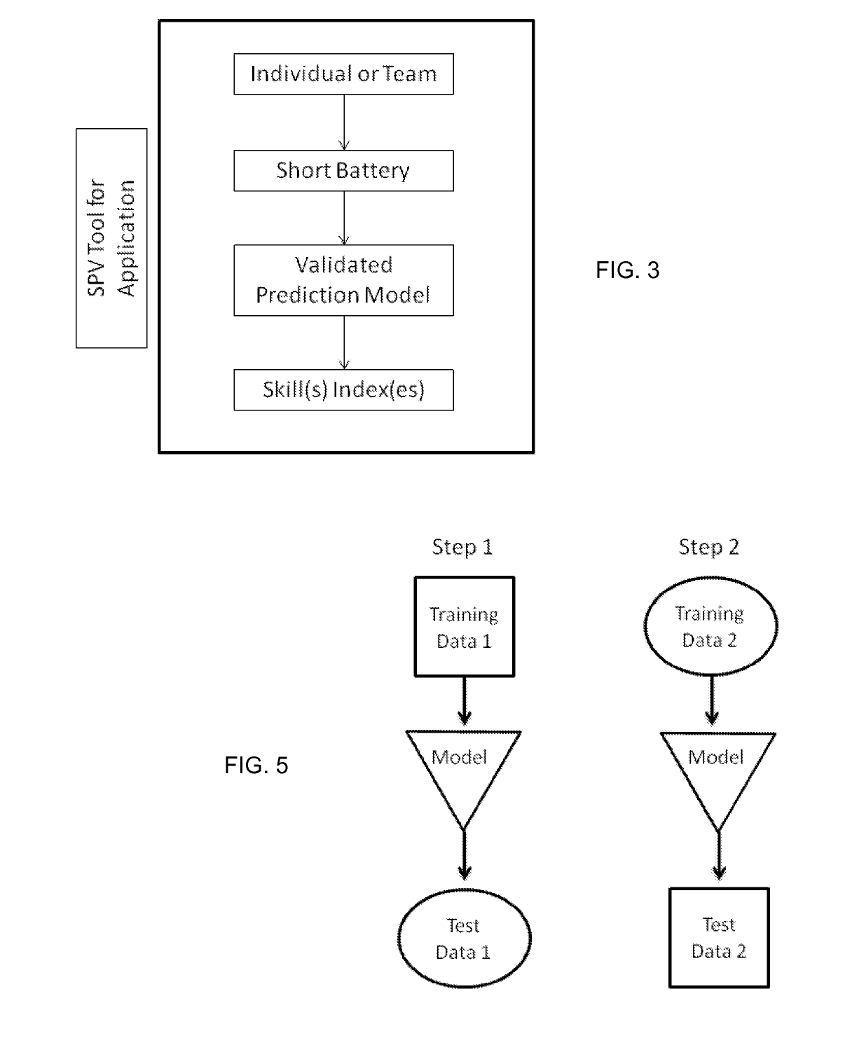

The short battery is integral in FIG. 2 and FIG. 3. In FIG. 2 there is shown an embodiment of a validation method for achieving a validated selection battery and validated prediction model. Validation Step 1 requires a group of people, also known as Sample 1, who are identified as being experts in a domain that necessitates a high skill level for a given skill or skills or identified as having an expert skill level for a given skill or skills. The short battery followed by a Task 1 is administered to the expert group. Task 1 is a longer task of a given skill or skills. It is preferable that part of the expert group completes a Task 2, which is also a longer task of a given skill or skills, in session 1 and part of the expert group completes Task 2 in a follow-up session. An initial model is made with the data from Task 1 and then Task 2. This model is then applied to Sample 2, which is preferably a group of people sought to select and predict. The short battery followed by a Task 1 is administered to Sample 2. The model built in Validation Step 1 is then used to select and predict individuals or teams for a given skill or skills. The model is expanded to include the data from Validation Step 2. The result of Validation Step 1 and 2 is a Validated Selection Battery and a Validated Prediction Model.

Once the short battery is created and validated and once the prediction model is trained and validated, advantageously using computer system 100, then the two can be applied for outputting individual or team skill indexes as shown in FIG. 3. Specifically, the short battery is administered to an individual or team and the responses are input in the validated prediction model for a resulting skill index.

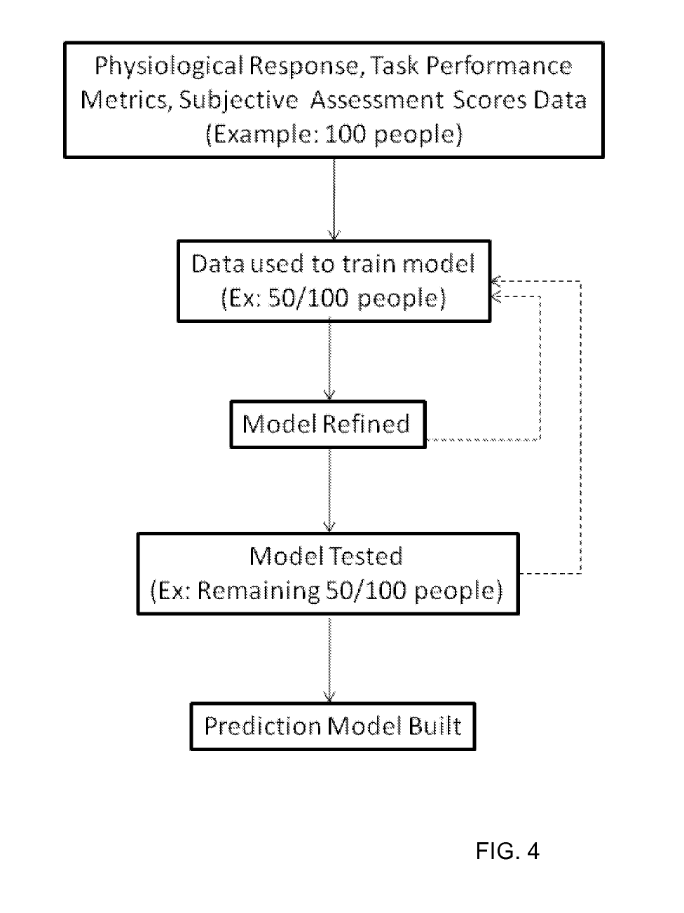

In FIG. 4 there is shown an embodiment of a method for building a validated prediction model. The prediction model uses the data of the physiological responses, performance metrics, and subjective scores as recorded before, during, and after the short battery. The model is built on Bayesian classifiers, support vector machine, neural networks, regression, or other complex statistical modeling techniques. In the instances of the first three techniques, training the model is necessary. Therefore, a portion of the data is used to build and train the initial model. The data is refined based upon beta weights, variance accounted for, minimizing covariance, and other applicable mathematic standards, any or all of which being advantageously calculated using computer system 100. The refined model is trained and then tested on the remaining data. This can be a cyclical process to optimize a model for a test group based on mathematic standards. The process would occur for all aspects of the validation of the disclosure, thus resulting in a refined and validated model. Because the volume of data is great, and the statistical calculations are extensive and difficult to carry out, and due to a need to generate results rapidly in order to timely iterate as described herein, one or more computer systems 100 are employed.

FIG. 5 is a diagram illustrating traditional machine learning within each domain compared with transfer learning across domains. As shown in this figure, many recent approaches of machine learning have focused on learning a model from massive amounts of data in one domain and making predictions for the same domain. While these approaches may at times make sense practically when such data is available, they do not apply when the availability of training data is limited, thus requiring the model to be rebuilt from scratch. Often, in the context of skill screening, not enough data is available for model development for each individual and for each task.

The present disclosure can use standard modeling practices or leverage transfer learning techniques to the domain of skill screening and provides a novel approach to faster and cheaper skill assessment with reliable and validated measures. Furthermore, this disclosure develops a methodology capable of generating data representations that can be reused and adapted from group to group and task to task.

In the method of the present disclosure, the skill assessment model can be developed using Bayes classifiers or any other probabilistic model that can be easily trained for groups and can adapt to individuals in different groups. During the adaptation process, the weights of some variables are adjusted to reflect the distribution changes of those variables from a group to individuals in a different group and from a task to a different task. The direct benefit of the transfer learning based method for skill screening is less time for reliable skill screening.

The instant inventor studied the relationship between cerebral blood flow velocity (CBFV) and subjective stress measures in order to predict the skill of vigilance. See Reinerman, Lauren E. Cerebral Blood Flow Velocity (CBFV) and Stress as Predictors of Vigilance, Masters Thesis, 2007, and the techniques therein may be used together with the instant disclosure, and are incorporated herein by reference.

The instant disclosure offers a more complete picture for prediction and selection of personnel for virtually any skill. The validation approach enables assured prediction of the best of the best for the selected skill or skills.

The model is created based upon a normalized sample of experts for a given skill; for example Chief Executive Officers (CEOs) for decision making. The shortened battery could is then used for new applicants for a job and their results would be compared within the model to make a prediction about the applicants' aptitude to make decisions as good as the CEOs' decisions. Therefore, the tool could be used for job selection for a given skill. The goal would be to hire applicants falling at the top end of the best of the best.

Additionally, the Selection, Prediction, and Validation (SPV) Tool of the disclosure could advantageously be used for assessing current employees' present skill level for decision making. Development opportunities for advancing this skill could be available or an employee with exceptional potential might be fast tracked.

The SPV Tool could be utilized further by comparing CEOs to determine a maintenance plan of the cognitive skill. Decision making is just one example of a skill. The battery could be tailored to capture any skill. After the validation phase, the measures given with the short battery (15-30 minutes) can be used for all future tests.

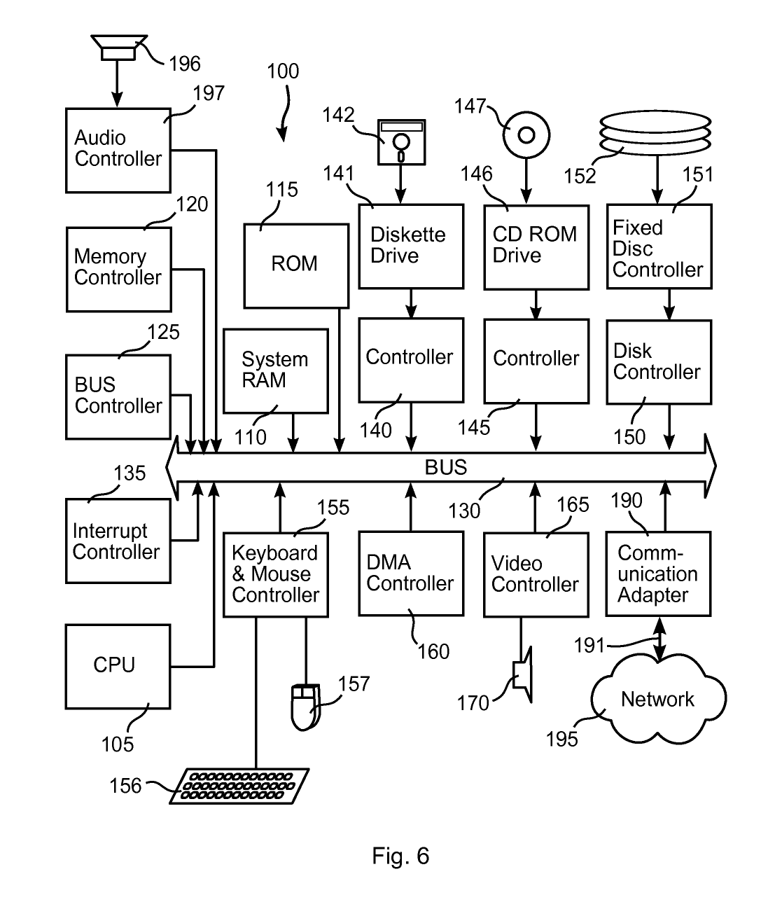

FIG. 6 illustrates the system architecture for a computer system 100 such as a server, work station or other processor on which the disclosure may be implemented. The exemplary computer system of FIG. 6 is for descriptive purposes only. Although the description may refer to terms commonly used in describing particular computer systems, the description and concepts equally apply to other systems, including systems having architectures dissimilar to FIG. 7.

Computer system 100 includes at least one central processing unit (CPU) 105, or server, which may be implemented with a conventional microprocessor, a random access memory (RAM) 110 for temporary storage of information, and a read only memory (ROM) 115 for permanent storage of information. A memory controller 120 is provided for controlling RAM 110.

A bus 130 interconnects the components of computer system 100. A bus controller 125 is provided for controlling bus 130. An interrupt controller 135 is used for receiving and processing various interrupt signals from the system components.

Mass storage may be provided by diskette 142, CD or DVD ROM 147, flash or rotating hard disk drive 152. Data and software, including software 400 of the disclosure, may be exchanged with computer system 100 via removable media such as diskette 142 and CD ROM 147. Diskette 142 is insertable into diskette drive 141 which is, in turn, connected to bus 30 by a controller 140. Similarly, CD ROM 147 is insertable into CD ROM drive 146 which is, in turn, connected to bus 130 by controller 145. Hard disk 152 is part of a fixed disk drive 151 which is connected to bus 130 by controller 150. It should be understood that other storage, peripheral, and computer processing means may be developed in the future, which may advantageously be used with the disclosure.

User input to computer system 100 may be provided by a number of devices. For example, a keyboard 156 and mouse 157 are connected to bus 130 by controller 155. An audio transducer 196, which may act as both a microphone and a speaker, is connected to bus 130 by audio controller 197, as illustrated. It will be obvious to those reasonably skilled in the art that other input devices, such as a pen and/or tablet, Personal Digital Assistant (PDA), mobile/cellular phone and other devices, may be connected to bus 130 and an appropriate controller and software, as required. DMA controller 160 is provided for performing direct memory access to RAM 110. A visual display is generated by video controller 165 which controls video display 170. Computer system 100 also includes a communications adapter 190 which allows the system to be interconnected to a local area network (LAN) or a wide area network (WAN), schematically illustrated by bus 191 and network 195.

Operation of computer system 100 is generally controlled and coordinated by operating system software, such as a Linux system, or a Windows system, commercially available from Microsoft Corp., Redmond, Wash. The operating system controls allocation of system resources and performs tasks such as processing scheduling, memory management, networking, and I/O services, among other things. In particular, an operating system resident in system memory and running on CPU 105 coordinates the operation of the other elements of computer system 100. The present disclosure may be implemented with any number of commercially available operating systems.

One or more applications, such as an HTML page server, or a commercially available communication application, may execute under the control of the operating system, operable to convey information to a user.

All patents and publications mentioned in this specification are indicative of the level of those skilled in the art to which the disclosure pertains. All patents and publications are herein incorporated by reference to the same extent as if each individual publication was specifically and individually indicated to be incorporated by reference. It is to be understood that while a certain form of the disclosure is illustrated, it is not intended to be limited to the specific form or arrangement herein described and shown. It will be apparent to those skilled in the art that various changes may be made without departing from the scope of the disclosure and the disclosure is not to be considered limited to what is shown and described in the specification. One skilled in the art will readily appreciate that the present disclosure is well adapted to carry out the objectives and obtain the ends and advantages mentioned, as well as those inherent therein. The described methods, techniques, tools, and apparatuses described herein are presently representative of the preferred embodiments, are intended to be exemplary and are not intended as limitations on the scope. Changes therein and other uses will occur to those skilled in the art which are encompassed within the spirit of the disclosure. Although the disclosure has been described in connection with specific, preferred embodiments, it should be understood that the disclosure as ultimately claimed should not be unduly limited to such specific embodiments. Indeed various modifications of the described modes for carrying out the disclosure which are obvious to those skilled in the art are intended to be within the scope of the disclosure.

What is claimed is:

1. A method for establishing a battery for evaluation of at least one skill of one or more individuals or group of individuals, the method comprising:
using at least one computer to execute software stored on non-transitory media, the software configured for
a) receiving data pertaining to at least one skill to be evaluated;
b) receiving data pertaining to identification of at least three components of the at least one skill selected in step (a);
c) receiving data pertaining to the selection of at least three tasks, each task corresponding to at least one of the three components identified in step (b);
d) receiving data pertaining to the administration of the tasks selected in step (c) to one or more individuals or group of individuals;
e) receiving data pertaining to responses to the tasks administered in step (d);
f) inputting all responses recorded in step (e) into a mathematical model; and
g) evaluating the model, whereby a battery is established by a skill index output, the battery useful for evaluating skills of other individuals.

2. The method according to claim 1, wherein the at least one skill selected in step (a) is decision-making.

3. The method according to claim 1, wherein one of the at least three tasks is a task for physiological assessment, one is a task for performance assessment, and one is a task for subjective assessment.

4. The method in accordance with claim 1, wherein the model may be re-used with a different set of one or more individuals or group of individuals or with a different skill.

5. A method for evaluation of at least one skill of one or more individuals or group of individuals to be tested, the method comprising:
using at least one computer to execute software stored on non-transitory media, the software configured for
a) receiving data pertaining to the selection of a first set of at least one task configured to test at least one selected skill to be evaluated;
b) receiving data pertaining to the selection of a second set of at least one task configured to test at least one selected skill to be evaluated;
c) receiving data pertaining to the selection of one or more individuals or group of individuals identified as experts identified as experts at the at least one skill selected in steps (a) and (b);
d) receiving data pertaining to the administration of the first and second sets of tasks to the one or more individuals or group of individuals identified as experts;
e) receiving data pertaining to responses to the task administered in step (d):
f) inputting all responses recorded in step (e) into a model; and
g) calculating, using the received data and a mathematical model, a set of skill indices;
h) using the calculated skill indices to evaluate one or more individuals or group of individuals of unknown skill, to select an individual having high aptitude for the skill.

6. The method in accordance with claim 5, wherein the model may be re-used with any group or skill.

7. The method in accordance with claim 5, wherein the first and second sets of at least one task are administered over different periods of time.

8. The method in accordance with claim 5, wherein the second set of at least one task is administered in two sessions.

9. A method of determining aptitude for a task, comprising:
using at least one computer to execute software stored on non-transitory media, the software configured for
receiving data pertaining to a plurality of core components of a skill related to the task;
receiving data pertaining to testing of individuals known to possess expert skills for the task, for the plurality of core components, the testing including at least one of physiological response, task performance, and a subjective assessment;
calculating one or more skill indices using the received data pertaining to testing, and a statistical model including at least one of Bayesian classifiers, support vector machine logic, neural network logic, or regression;
receiving data pertaining to testing of individuals not known to possess expert skills for the task, for the plurality of core components, the testing including at least one of physiological response, task performance, and a subjective assessment;
comparing the received data pertaining to testing of individuals not known to possess expert skills and the calculated skill indices of the tested individuals known to possess expert skills, to improve a prediction of aptitude for the skill of individuals not known to possess expert skills.

10. The method according to claim 9, wherein at least one of the core components is decision making.

11. The method according to claim 9, wherein the received data pertaining to testing of individuals known to possess expert skills pertains to testing of one or more of the plurality of core components being tested more than once.

12. The method according to claim 9, wherein the received data pertaining to testing of individuals known to possess expert skills pertains to first and second tests administered at separate times, the first test being a short test, and the second test being a longer, more comprehensive test than the first test.

13. The method according to claim 12, wherein first and second test are given to individuals not known to possess expert skills, and the software further
calculates a first statistical evaluation of the results of the first and second tests of the individuals known to possess expert skills, and
calculates a second statistical evaluation of the results of the first and second tests of the individuals not known to possess expert skills, and compares the first and second statistical analysis to determine aptitude of the individuals not known to possess expert skills, for the task.

14. The method according to claim 9, wherein the software is further configured to calculate, using at least one of beta weights, variance accounted for, and minimizing covariance, an improvement to a value of the statistical model to predict aptitude of the individuals not known to be experts.

15. The method according to claim 14, wherein the software iteratively calculates after each test, to improve the statistical model.

16. The method according to claim 9, wherein a job held by the individuals known to be experts is different than a job for which the individuals not known to be experts are being evaluated.

17. The method according to claim 9, wherein the task is cognitive or physical.

18. The method according to claim 9, wherein the data received pertaining to testing is gathered at least one of before, during, and after the task is performed.

19. The method according to claim 9, wherein data received pertaining to testing pertains to the individuals detecting the presence or absence of a stimulus.

20. The method according to claim 10, wherein the plurality of core components include components of differing skill levels.
